(19) United States
(12) Patent Application Publication
(10) Pub. No.: US 2025/0388759 A1
(43) Pub. Date: Dec. 25, 2025

(54) CARBON BLACK PELLETS CONTAINING GRAPHENE

(71) Applicant: Continental Carbon Co., Houston, TX (US)

(72) Inventors: Raymond SOUFIANI, Katy, TX (US); Lashan M.H. DE SILVA, Dickinson, TX (US); Angel Jose MARCUCCI, Spring, TX (US); Michael Brendan RODGERS, Leander, TX (US); Eduardo VEGA, JR., Richmond, TX (US)

(21) Appl. No.: 19/243,942

(22) Filed: Jun. 20, 2025

Related U.S. Application Data
(60) Provisional application No. 63/661,948, filed on Jun. 20, 2024.

(51) Int. Cl. C09C 1/60; C09C 3/04

(52) U.S. Cl. CPC C09C 1/60; C09C 3/045; C01P 2004/54

(57) ABSTRACT

The addition of graphene to the pelletizing of carbon black during carbon black's manufacturing can allow a higher level of dispersion and exfoliation of the graphene when carbon black is compounded in rubber. This is applicable to pelletization of all grades of carbon black with all classes of graphene such as graphene oxide, reduced graphene oxide, and pure graphene, and which any graphene organic functionality will have minimal effect. Amounts of graphene incorporated into the carbon black pellets will be from about 0.01 weight percent to about 30 weight percent, including as an example, between about 0.03 and about 6 weight percent. The use of carbon black as a carrier will mitigate graphene dusting (safety benefits), maximize dispersion in a rubber compound (processing benefits), and facilitate full attainment of rubber compound material properties through the inclusion of graphene (performance benefits).

### I. Background

This application claims the benefit of U.S. provisional patent application Ser. No. 63/661,948, filed Jun. 20, 2024, the contents of which are incorporated herein by reference. The present teaching is related to carbon black pellets, and more particularly to carbon black pellets containing graphene.

Tires, as a vehicle's sole link with the roadway, play a key role in automotive safety and also have a direct influence on fuel consumption, as well as many other vehicle/tire system characteristics. The performance of a tire is governed by three fundamental elements 1) the design, 2) the construction used in the design, and 3) the materials, including reinforcements such as fabric and steel wire. Of the three elements, the materials, and specifically the compounds, play a critical role in defining a tire's performance envelope. Compounded rubber has many unique characteristics not found in other materials, such as dampening properties, high elasticity, and abrasion resistance. Hence, in addition to tires, rubber has found use in applications such as conveyor belts, large dock fenders, building foundations, automotive engine components, and a wide range of domestic appliances such as O-rings in appliances. The ingredients available to the materials scientist for formulating a rubber compound can be divided into five categories:
1. Polymers such as natural rubber (NR) or synthetic rubber including styrene butadiene copolymers (SBR), polybutadiene (BR), EPDM polychloroprene rubber (CR) and nitrile rubber (NBR);
2. Filler systems and examples include carbon black, silica, clay, talc, and calcium carbonate;
3. Stabilizer system which includes antioxidants and antiozonants;
4. Vulcanization system which can include sulfur, accelerators, or alternatively peroxides as an example; and
5. Process aids and other additives such as oils and resins, homogenizing agents, pigments, and specialty materials to promote a specific property such as use of cobalt salts to increase rubber to brass coated wire adhesion.

Carbon black is the dominant filler used in the compounding of rubber. It has three functions, i) improve the processing of rubber compounds by minimizing the elasticity sometimes described in processing and manufacturing of rubber products as compound “nerve,” ii) improve the mechanical properties of the rubber compound formulation, and iii) optimize a formulation's cost.

The grades of carbon black are well defined. To those familiar with carbon black technology, the material will fall into one of three classes depending on the manufacturing process, i) furnace grades, ii) thermal types, and iii) acetylene types. All three classes can have the same types of feedstocks, i.e., crude oil, tars, or natural gas. In terms of global production, furnace type carbon black grades are the dominant type due to the reinforcing properties in rubber compounds. Thermal grades are much less reinforcing though still find application in tires and specifically in tire innerliners. Acetylene grades, which have much larger particle sizes, find use in applications where greater thermal and electrical conductivity is required.

Furnace grades of carbon black fall into one of seven groups depending on the particle size (Table I). These are super abrasion furnace (SAF), intermediate super abrasion furnace (ISAF), and high abrasion furnace (HAF) grades which are used, for example, in tread compounds or conveyor belt cover compounds. This is followed by fast furnace (FF), fast extrusion furnace (FEF), general purpose furnace (GPF), and semi-reinforcing furnace (SRF) grades which are used in tire casing compounds and other components which are parts of industrial rubber products. Grades of carbon back within each of the seven groups are also well defined as shown in Table II and further described in the industrial standard, ASTM D1765, of which rubber technologists are very familiar.

TABLE I
Tire and Industrial Products Carbon Black Categories

| | | Particle Size | |
|---|---|---|---|
| Group | ASTM | m²/gm | Application |
| SAF | N110 | 11-19 | Tread |
| ISAR | N220 | 20-25 | Tread |
| HAF | N330 | 26-30 | Tread, Casing |
| FF | N475 | 31-39 | Industrial products |
| FEF | N550 | 40-49 | Tire casings, |
| | | | Industrial products |
| GPF | N660 | 50-60 | Tire casings, industrial |
| | | | products |
| SRF | N762 | 61-100 | Industrial products |

TABLE II
Common Commercial Grades of Carbon Black

| | | Oil | Compressed | | | |
|---|---|---|---|---|---|---|
| ASTM | | Absorp- | Oil | NSA | | |
| Designa- | Iodine | tion | Absorption | Multi- | | Tint |
| tion | Number | Number | Number | point | STSA | Strength |
| N110 | 145 | 113 | 98 | 126 | 115 | 124 |
| N115 | 160 | 113 | 96 | 137 | 124 | 123 |
| N120 | 120 | 114 | 99 | 122 | 114 | 129 |
| N121 | 121 | 132 | 112 | 121 | 114 | 119 |
| N125 | 117 | 104 | 89 | 122 | 121 | 125 |
| N134 | 142 | 127 | 103 | 143 | 137 | 131 |
| N220 | 121 | 114 | 100 | 119 | 106 | 115 |
| N231 | 121 | 92 | 86 | 108 | 107 | 117 |
| N234 | 120 | 125 | 100 | 119 | 112 | 124 |
| N299 | 108 | 125 | 105 | 104 | 97 | 113 |
| N326 | 82 | 72 | 69 | 78 | 76 | 112 |
| N330 | 82 | 102 | 88 | 82 | 75 | 103 |
| N339 | 90 | 120 | 101 | 93 | 88 | 110 |
| N347 | 90 | 124 | 100 | 85 | 83 | 103 |
| N351 | 68 | 120 | 97 | 73 | 70 | 100 |
| N358 | 84 | 150 | 108 | 80 | 87 | 98 |
| N375 | 90 | 114 | 97 | 96 | 78 | 115 |
| N550 | 43 | 121 | 88 | 42 | 39 | |
| N630 | 36 | 78 | 62 | 32 | 32 | |
| N650 | 36 | 122 | 84 | 36 | 35 | |
| N660 | 36 | 90 | 75 | 35 | 34 | |
| N762 | 27 | 65 | 57 | 29 | 28 | |
| N772 | 30 | 65 | 58 | 32 | 30 | |
| N990 | | 38 | 37 | 9 | 8 | |
| N991 | | 35 | 37 | 8 | 8 | |

The selection of any grade of carbon black for a tire component, or other compound used in an industrial product, will depend on the mission profile and performance envelope of the end product. For example, the carbon black grades, N110, N121, and N234 are most suitable for excellent abrasion resistance and are thus used in tire tread compounds. Due to the large particle size, grades such as N660 and N762 are suitable for use in sheets or liners where low permeability is required.

Improvement in carbon black properties and development of new grades for tires is constrained due to tire production factory capabilities, specifically the limited number of carbon black silos and towers to hold additional or new grades. Despite this, considerable effort in improving carbon black has been undertaken. One approach to improve the compound properties is chemical modification of carbon blacks to increase the filler-polymer interactions. Enormous studies of surface treatment of carbon blacks have been conducted in this approach (e.g., see U.S. Pat. No. 5,494,955). Although improvement in rolling resistance or other properties was achieved, they were not successful in simultaneous improvement of all three properties: rolling resistance, wet traction, and wear resistance. Although filler-polymer interactions were improved, filler-filler networking was still predominant.

U.S. Pub. No. 2013/0046064 describes usage of functionalized polymer with surface treated carbon black to improve rolling resistance, wet traction, and wear resistance comparable to silica. This functionalized carbon black offers a processing and performance benefit comparable to functionalized solution SBR-silica compositions. However, functionalized polymers are expensive and, in many instances, not practical to use from a cost basis. An ongoing need thus exists for compound filler and reinforcing materials that provide enhanced compound properties.

### II. Summary

One means by which a carbon black's properties can be enhanced both with and without chemical modification is use of additives. Graphene represents a new class of tire materials permitting significant performance improvement with no loss in secondary properties frequently experienced with new materials.

Graphene is available in three types, graphene oxide (GO), reduced graphene oxide (rGO), and pure graphene, sometimes referred to as pristine graphene. The quality of the graphene will be a function of the source of graphite from which it can be produced and the manufacturing process, among other factors. For explanatory purposes, a simple illustration of the different types of graphene is shown in FIG. 1.

Graphene is a fine powder, appearing as a dust, and when spilled may present slip hazards. This would require correction before use in a rubber goods manufacturing facility such as tire production factories.

Graphene, when added to composites, is reported to improve thermal and electrical conductivity, abrasion resistance, hysteresis depending on the type, reduce permeability, and acts as an antioxidant. It has also been reported that when graphene is added to a rubber compound there are no to little effects on compound processing, vulcanization, or fundamental mechanical properties, in particular for pristine graphene, and low levels of chemical functionality in reduced graphene. However, the primary constraint on use of graphene in manufacturing and industrial production of final products such as tires is the form of graphene as a light fluffy material. For use in manufacturing, it must be dust free, may not be airborne, nor be in a form that renders it unusable.

Similarly for carbon black, which is also a dust or powder and thus must be pelletized in order to facilitate industrial use, transportable via pneumatic conveyor systems, not show compaction, and function in automatic weigh-up systems. FIG. 2 illustrates a schematic of the carbon black manufacturing process. Additional description of the carbon black manufacturing process can be found in the text, Rubber Compounding, Chemistry and Applications, published by CRC Press, 2^{nd} edition.

A method to improve the performance of conventional carbon black grades via co-pelletization with graphene.

A bromobutyl innerliner compound containing pristine graphene that will reduce the permeation coefficient of the innerliner membrane.

Co-pelletization of graphene with carbon black thus facilitating dust suppression and therefore with safety and environmental benefits.

Pelletization of graphene with carbon black thus allowing a higher degree of dispersion in a rubber compound.

Co-pelletization of graphene with carbon black enabling graphene to attain a higher level of exfoliation in a rubber compound.

Increase in graphene dispersion and uniformity thus facilitating a decrease in the Payne Effect, in turn allowing reductions in the contribution of the innerliner compound to whole tire hysteresis.

Addition of graphene via co-pelletization with carbon black thus increasing the dispersion and uniformity in a rubber compound, and in turn, improving effective gas barrier properties,

Inclusion of graphene in co-pelletized carbon black showing reduced permeability but no loss in secondary properties.

Addition of graphene to carbon black grade N660 typically used for tire innerliners thereby allowing improvement in tire air pressure retention.

### III. Brief Description of the Drawings

The disclosure may take physical form in certain parts and arrangement of parts, aspects of which will be described in detail in this specification and illustrated in the accompanying drawings which form a part hereof and wherein:

FIG. 1 shows various forms of graphene;

FIG. 2 shows a schematic of carbon black manufacturing;

FIG. 3 shows allotropes of carbon;

FIG. 4 shows degrees of dispersion of sheets in a rubber compound; and

FIG. 5 shows increasing sheet aspect ratio and reduced permeability.

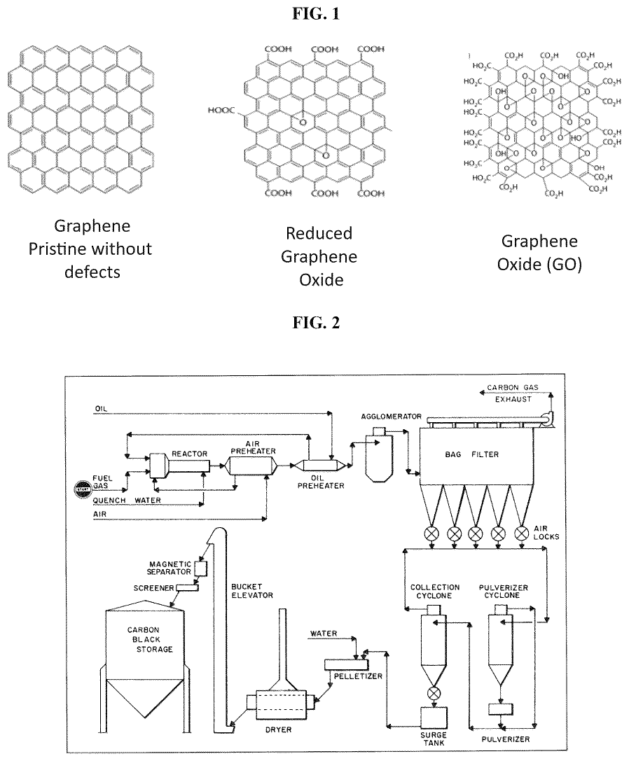

### IV. Detailed Description

The addition of graphene after filtration and before the surge tank prior to pelletization of the carbon black and then co-pelletization of carbon black and graphene will address potential concerns of dust and industrial hygiene regarding free graphene. By adding and blending graphene to the carbon black in dust form it will achieve a high degree of dispersion, enhance the properties of the carbon black, without negating the range of compound design variables required in the end-product. For example, addition of pristine graphene to carbon black and specifically grade N660 for tire innerliners will facilitate reduced permeability without shifting or processing of mechanical properties.

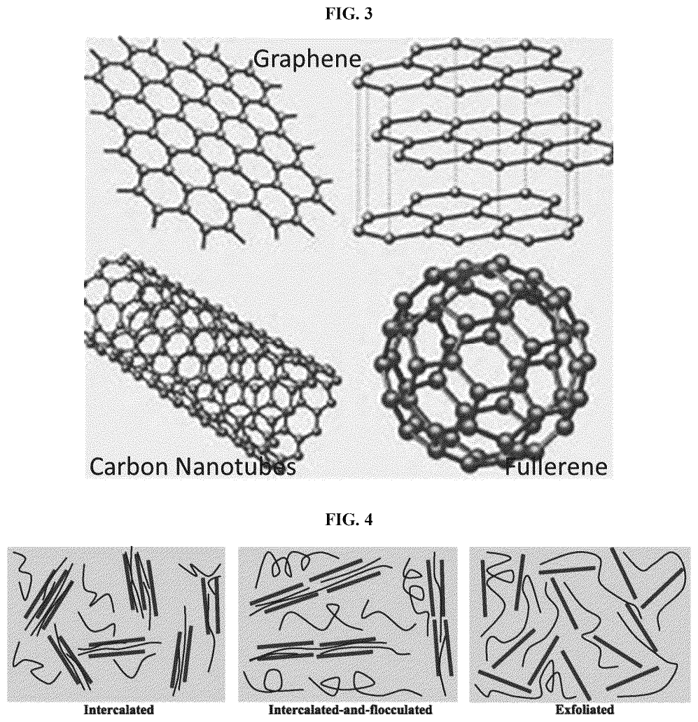

The co-pelletization of carbon black with graphene will include all furnace grades of carbon black, thermal grades, and acetylene grades. Graphene can be one of three types, pristine graphene, reduced graphene oxide, or graphene oxide. Graphene is an allotrope of carbon consisting of a single layer of carbon atoms, in 6-member aromatic rings, and arranged in a two-dimensional honeycomb lattice. The hexagonal lattice structure of isolated, single-layer graphene can be directly seen with transmission electron microscopy (TEM), and sheets under scanning electron microscopy (SEM). It is recognized that graphene is one of three types of allotropes, the others being fullerenes, and carbon nanotubes (FIG. 3).

Fullerenes are spheres and thus have limited utility in rubber compounding. Carbon nanotubes are reported to improve electrical and thermal conductivity but due to multi-wall configurations and the low surface area, these have limited utility in rubber compounding. Graphene is a sheet and readily exfoliates, i.e., exists in single sheets up to 20 microns in diameter and with a thickness in the order of angstroms. It is therefore highly efficient in promoting properties such as barrier properties, antioxidant properties as a free radical scavenger, and thermal and electrical properties, not achievable with allotropes in the form of spheres or tubes as shown in FIG. 3.

Graphene dispersed in a carbon black matrix during the pelletization process would exist in one of three forms, i) as single exfoliated sheets, ii) intercalated sheets consisting of 3 or more sheets, and iii) flocculated agglomerates consisting of stacks greater than 20 sheets of graphene (FIG. 4). In carbon black, graphene would assume a near fully exfoliated state or be fully exfoliated during the pelletization process thus allowing:
1. Full dust suppression;
2. Maximized dispersion when compounded; and
3. Full achievement of the theoretical compound properties achievable using graphene such as permeability reductions.

### Example 1

The present teaching can be any ASTM defined grade of carbon black as described in Table II, i.e., any furnace type grade, any acetylene type of carbon black, or any thermal grade of carbon black. It also includes all types of graphene: pure graphene, graphene oxide, and reduced graphene oxide. The present teaching utilizes co-pelletized carbon black with graphene, creating the following benefits:
1. Eliminating dusting during mixing due to graphene with environmental benefits;
2. Maximizing the dispersion of graphene in a rubber compound where the carbon black-graphene complex is produced and applied;
3. Eliminating the need for an additional item in rubber goods factory raw materials inventory; and
4. Enhancing safety through simplification of materials handling systems.

### Example 2. Composition

The present teaching can be any ASTM defined grade of carbon black as described in Table II, i.e., any furnace type grade, any acetylene type of carbon black, or any thermal grade of carbon black. It also includes all types of graphene: pure graphene, graphene oxide, and reduced graphene oxide. The amount of graphene incorporated into the carbon black pellets will be from about 0.01 weight percent to about 30 weight percent, including, as an example, between about 0.03 and about 6 weight percent.

In this example, pristine graphene was added to a model tire innerliner formulation containing bromobutyl rubber and N660 carbon black. Graphene was added at 2.0, 4.0, 10 phr and 15 phr. The formulations are shown in table III with Compound 1 representing the control and Compounds 2 to 5 showing the incremental increase in free graphene.

The results indicated that graphene had no detrimental effect on compound properties. Mooney viscosity was satisfactory and Mooney scorch times were equal. Such effects would be expected from pristine graphene since it is chemically inert.

Graphene was then co-pelletized with N660 carbon black at the same levels (Compound 6, 7, 8, and 9). Again, compound property trends were similar to that for freely added graphene.

TABLE III
Compound Formulations and Processing Properties

| | Compound | | | | | | | | |
|---|---|---|---|---|---|---|---|---|---|
| | 1 | 2 | 3 | 4 | 5 | 6 | 7 | 8 | 9 |
| Bromobutyl (32MU) | 100.00 | 100.00 | 100.00 | 100.00 | 100.00 | 100.00 | 100.00 | 100.00 | 100.00 |
| Carbon Black. N660 | 60.00 | 60.00 | 60.00 | 60.00 | 60.00 | 60.00 | 60.00 | 60.00 | 60.00 |
| Graphene | | 2.00 | 4.00 | 10.00 | 15.00 | 2.00 | 4.00 | 10.00 | 15.00 |
| Naphthenic Oil | 8.00 | 8.00 | 8.00 | 8.00 | 8.00 | 8.00 | 8.00 | 8.00 | 8.00 |
| Tackifying Resin | 7.00 | 7.00 | 7.00 | 7.00 | 7.00 | 7.00 | 7.00 | 7.00 | 7.00 |
| Homogenizing Resin | 4.00 | 4.00 | 4.00 | 4.00 | 4.00 | 4.00 | 4.00 | 4.00 | 4.00 |
| Stearic Acid | 1.00 | 1.00 | 1.00 | 1.00 | 1.00 | 1.00 | 1.00 | 1.00 | 1.00 |
| Zinc Oxide | 1.00 | 1.00 | 1.00 | 1.00 | 1.00 | 1.00 | 1.00 | 1.00 | 1.00 |
| MBTS Accelerator | 1.25 | 1.25 | 1.25 | 1.25 | 1.25 | 1.25 | 1.25 | 1.25 | 1.25 |
| Sulfur | 0.50 | 0.50 | 0.50 | 0.50 | 0.50 | 0.50 | 0.50 | 0.50 | 0.50 |
| Graphene PHR | 0 | 2 | 4 | 10 | 15 | 2 | 4 | 10 | 15 |
| | | Powder | Powder | Powder | Powder | Pelletized | Pelletized | Pelletized | Pelletized |
| Mooney Viscosity | | | | | | | | | |
| Peak MU | 76.93 | 74.23 | 73.37 | 69.89 | 66.84 | 78.79 | 71.83 | 71.23 | 67.62 |
| ML 1 + 4 @ 100° C.MU | 58.06 | 56.42 | 55.44 | 52.78 | 50.92 | 55.84 | 55.3 | 52.81 | 50.82 |
| Dispergrader | 98.3 | 91.82 | 91.35 | 94.47 | 93.71 | 93.66 | 91.8 | 94.25 | 95.52 |
| % dispersion @ 100X | | | | | | | | | |
| Mooney Scorch, 125° C. | | | | | | | | | |
| Viscosity (MU) | 41.59 | 39.77 | 39.03 | 37.49 | 36.35 | 38.85 | 38.84 | 37.11 | 35.71 |
| T_{S}5, min | 19.37 | 18.07 | 18.42 | 18.74 | 19.09 | 18.85 | 18.94 | 18.61 | 18.63 |
| T_{S}10, min | 24.56 | 24.1 | 24.01 | 24.49 | 24.25 | 24.99 | 24.88 | 24.78 | 24.78 |
| T_{S}35, min | 30.34 | 30.17 | 30.1 | 30.64 | 30.61 | 31.12 | 31.21 | 31.13 | 31.22 |

The compound mechanical properties are shown in Table IV. There was no change in the state of cure, delta torque from the RPA test, nor a significant change in tensile strength. Table IV showed that for both freely added graphene and co-pelletized graphene the Payne effect dropped inferring lower hysteresis and improved rolling resistance in tread compounds. In this instance the improved Payne effect could be attributed to improved compound uniformity due to shear created by graphene addition.

TABLE IV
Compound Properties

| | Compound | | | | | | | | |
|---|---|---|---|---|---|---|---|---|---|
| | 1 | 2 | 3 | 4 | 5 | 6 | 7 | 8 | 9 |
| Bromobutyl (32MU) | 100.00 | 100.00 | 100.00 | 100.00 | 100.00 | 100.00 | 100.00 | 100.00 | 100.00 |
| Carbon Black. N660 | 60.00 | 60.00 | 60.00 | 60.00 | 60.00 | 60.00 | 60.00 | 60.00 | 60.00 |
| Graphene | | 2.00 | 4.00 | 10.00 | 15.00 | 2.00 | 4.00 | 10.00 | 15.00 |
| | | Free | Free | Free | Free | Pelletized | Pelletized | Pelletized | Pelletized |
| RPA Cure @ 160° C. | | | | | | | | | |
| ML, dNm | 1.32 | 1.31 | 1.28 | 1.21 | 1.23 | 1.30 | 1.29 | 1.23 | 1.21 |
| MH, dNm | 5.49 | 5.26 | 5.12 | 4.95 | 4.85 | 5.29 | 5.13 | 4.97 | 4.80 |
| MH-ML, dNm | 4.17 | 3.95 | 3.84 | 3.74 | 3.61 | 3.99 | 3.84 | 3.74 | 3.59 |
| T_{C}10, min | 2.07 | 2.11 | 2.07 | 2.00 | 2.09 | 2.17 | 2.11 | 2.15 | 2.16 |
| T_{C}50, min | 4.63 | 4.49 | 4.49 | 4.40 | 4.47 | 4.65 | 4.51 | 4.56 | 4.55 |
| T_{C}90, min | 11.08 | 9.74 | 9.69 | 9.46 | 9.75 | 10.84 | 9.66 | 9.85 | 9.86 |
| Cure Rate Index | 11.10 | 13.11 | 13.12 | 13.40 | 13.05 | 11.53 | 13.25 | 12.99 | 12.99 |
| Payne Effect | | | | | | | | | |
| G′_{0.1}, kPa | 716.065 | 676.893 | 646.291 | 611.282 | 534.171 | 686.405 | 658.973 | 600.992 | 533.829 |
| G′₁₀, kPa | 316.519 | 299.179 | 294.543 | 291.938 | 279.559 | 293.576 | 295.484 | 285.860 | 277.964 |
| ΔG′, kPa | 399.55 | 377.71 | 351.75 | 319.34 | 254.61 | 392.83 | 363.49 | 315.13 | 255.87 |
| Tensile Strength | | | | | | | | | |
| Tensile, MPa | 9.80 | 9.31 | 9.59 | 8.68 | 9.19 | 9.71 | 8.62 | 9.79 | 8.88 |
| Elongation, % | 846.97 | 845.92 | 839.08 | 775.32 | 828.69 | 855.22 | 793.37 | 849.70 | 791.93 |
| M100%, MPa | 1.40 | 1.46 | 1.46 | 1.60 | 1.63 | 1.44 | 1.36 | 1.57 | 1.65 |
| M200%, MPa | 2.38 | 2.40 | 2.43 | 2.65 | 2.69 | 2.35 | 2.23 | 2.60 | 2.75 |
| M300%, MPa | 3.61 | 3.50 | 3.53 | 3.67 | 3.63 | 3.46 | 3.24 | 3.62 | 3.73 |
| M300/M100 | 2.57 | 2.40 | 2.42 | 2.30 | 2.23 | 2.41 | 2.38 | 2.31 | 2.26 |
| Hardness Shore A | 54.00 | 54.00 | 54.00 | 54.00 | 53.00 | 54.00 | 54.00 | 55.00 | 54.00 |

### Example 3. Attainment of Reduced Permeability

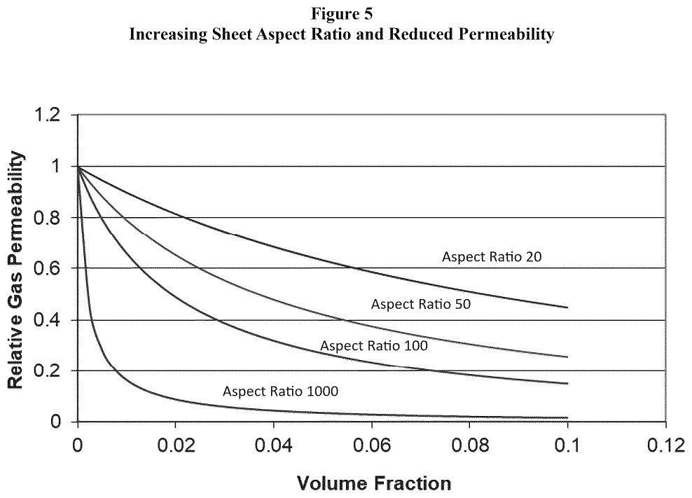

Graphene can have aspect ratios above 1000, i.e., when the graphene sheet is up to 15 microns and the thickness in the order of 5 to 15 angstroms. In an exfoliated condition which is understood to be readily achievable with graphene in carbon black, when compared to organoclays in elastomers, then substantial reductions in permeability, such as is required for tire innerliners is attainable (FIG. 5).

Given apparent improved compound homogeneity allowing a reduction in the Payne Effect, co-pelletization will facilitate a greater degree of intercalation and exfoliation of graphene in the compound. Though the aspect ratio of graphene is very high, orientation will negate the attainment of permeability reductions shown in FIG. 5. For best properties graphene aspect ratios of 1000 are preferred but also, the graphene plates must be oriented perpendicular to gas flow. For freely added graphene, a modeled aspect ratio of 50 was thus assessed. From the model illustrated in FIG. 5, permeation coefficients in cc*mm/(m²-day) dropped from 195 with no graphene to 87.7 when using 15 phr of graphene.

Pelletization will be more effective in dispersing graphene prior to final compound mixing thus allowing a higher effective aspect ratio. With a higher effective aspect ratio orientation parallel to the grain of the liner sheet will be achieved. From the model and given an aspect ratio of 100, the permeation coefficients dropped from 195 to 41 cc*mm/(m²-day) with 15 phr graphene (Table V). This compares with kaolin clays with a nominal aspect ratio in the range of 15 to 20. Graphene is thus much superior.

TABLE V
Predicted Permeation Coefficients

| | Compound | | | | | | | | |
|---|---|---|---|---|---|---|---|---|---|
| | 1 | 2 | 3 | 4 | 5 | 6 | 7 | 8 | 9 |
| Bromobutyl (32MU) | 100.00 | 100.00 | 100.00 | 100.00 | 100.00 | 100.00 | 100.00 | 100.00 | 100.00 |
| Carbon Black. N660 | 60.00 | 60.00 | 60.00 | 60.00 | 60.00 | 60.00 | 60.00 | 60.00 | 60.00 |
| Graphene | | 2.00 | 4.00 | 10.00 | 15.00 | 2.00 | 4.00 | 10.00 | 15.00 |
| | | Free | Free | Free | Free | Pelletized | Pelletized | Pelletized | Pelletized |
| Zwick Rebound | | | | | | | | | |
| 0° C. | 8 | 8 | 8 | 8 | 8 | 8 | 8 | 8 | 8 |
| 20° C. | 14 | 12 | 12 | 11 | 12 | 12 | 12 | 12 | 12 |
| 60° C. | 33 | 33 | 33 | 33 | 34 | 31 | 33 | 33 | 33 |
| Permeability | | | | | | | | | |
| Estimated Aspect Rati | — | 50 | 50 | 50 | 50 | 100 | 100 | 100 | 100 |
| vol % in Compound | — | 0.57 | 1.14 | 2.87 | 4.31 | 0.57 | 1.14 | 2.87 | 4.31 |
| Relative Permeability | 1 | 0.82 | 0.77 | 0.56 | 0.45 | 0.67 | 0.5 | 0.4 | 0.21 |
| cc*mm/(m²*day) | 195 | 169.9 | 120.05 | 109.2 | 87.7 | 131 | 97.5 | 78 | 40.9 |

### Example 4; Orientation of Graphene Sheets

Orientation of graphene sheets perpendicular to the gas flow through a membrane such as a tire innerliner is important in maximizing barrier properties. This is readily achieved in the tire or other membrane manufacturing during the sheet extrusion or calendering operations. The sheets will align in the direction of flow. This characteristic is well established in tire and industrial products manufacturing and is sometimes referred to as the “direction of the grain.” By preparing the graphene as part of the carbon black pellets, a higher degree of exfoliation is obtained, thus facilitating dispersion and subsequent alignment with the direction of grain in the rubber sheet, e.g., the innerliner of a tire.

### Example 5. Tire Curing

Further application may be in tire curing bladders. It has been reported that graphene may increase the performance of bladders due to i) the antioxidant properties, ii) improved thermal conductivity, iii) reduced permeability of moisture, oxygen, and nitrogen, and iv) bladder compound homogeneity (see Rubber Word Vol 270, No 2. P 42. 2024). Dispersion and graphene plate alignment may be enhanced by co-pelletizing carbon black and graphene. The consequent improved thermal conductivity of the bladder compound will allow faster heat transfer into the curing tire with consequent reductions in tire cure time, thus being beneficial for tire production rates.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Accordingly, the scope of protection is not limited by the description set out above but is only limited by the claims which follow, that scope including all equivalents of the subject matter of the claims. Each and every claim is incorporated into the specification as an aspect of the present teaching. Thus, the claims are a further description and are an addition to the aspects of the present teaching. The discussion of a reference herein is not an admission that it is prior art, especially any reference that may have a publication date after the priority date of this application. The disclosures of all patents, patent applications, and publications cited herein are hereby incorporated by reference, to the extent that they provide exemplary, procedural, or other details supplementary to those set forth herein.

We claim:

1. An additive pellet, the pellet comprising:
carbon black co-pelletized with graphene, wherein the carbon black is chosen from the group consisting of furnace grade carbon black, thermal grade carbon black, and acetylene grade carbon black, wherein the graphene is chosen from the group consisting of pristine graphene, graphene oxide, and reduced graphene oxide.

2. The pellet of claim 1, wherein the graphene is from about 0.01 weight percent to about 30 weight percent.

3. The pellet of claim 2, wherein the graphene is from about 0.03 weight percent to about 6 weight percent.

4. The pellet of claim 1, wherein the graphene has an aspect ratio of at least 1000.

5. The pellet of claim 4, wherein the graphene has a thickness of about 5 Angstroms to about 15 Angstroms.

6. The pellet of claim 1, wherein the graphene is chosen from the group consisting of exfoliated sheets, intercalated sheets consisting of three or more sheets, and flocculated agglomerates consisting of twenty or more sheets.

7. The pellet of claim 1, wherein the graphene is pristine graphene.

8. The pellet of claim 1, wherein the graphene is graphene oxide.

9. The pellet of claim 1, wherein the graphene is reduced graphene oxide.

10. A method for pelletizing carbon black and graphene, the method comprising the steps of:
co-pelletizing carbon black and graphene, wherein the carbon black is chosen from the group consisting of furnace grade carbon black, thermal grade carbon black, and acetylene grade carbon black, wherein the graphene is chosen from the group consisting of pristine graphene, graphene oxide, and reduced graphene oxide.

11. The method of claim 10, wherein the graphene is added to the carbon black for co-pelletization after filtration and before a surge tank.

12. The method of claim 10, wherein the graphene is from about 0.01 weight percent to about 30 weight percent.

13. The method of claim 12, wherein the graphene is from about 0.03 weight percent to about 6 weight percent.

14. The method of claim 10, wherein the graphene has an aspect ratio of at least 1000.

15. The method of claim 14, wherein the graphene has a thickness of about 5 Angstroms to about 15 Angstroms.

16. The method of claim 10, wherein the graphene is chosen from the group consisting of exfoliated sheets, intercalated sheets consisting of three or more sheets, and flocculated agglomerates consisting of twenty or more sheets.

17. The method of claim 10, wherein the graphene is pristine graphene.

18. The method of claim 10, wherein the graphene is graphene oxide.

19. The method of claim 10, wherein the graphene is reduced graphene oxide.
